(19) United States
(12) Patent Application Publication
(10) Pub. No.: US 2024/0184738 A1
(43) Pub. Date: Jun. 6, 2024

(54) CONFIGURABLE MEMORY POOL SYSTEM

(71) Applicants: The Regents of the University of California, Oakland, CA (US); The Board of Trustees of the University of Illinois, Urbana, IL (US)

(72) Inventors: Saptadeep PAL, Los Angeles, CA (US); Matthew TOMEI, Champaign, IL (US); Puneet GUPTA, Los Angeles, CA (US); Rakesh KUMAR, Champaign, IL (US)

(73) Assignees: The Regents of the University of California, Oakland, CA (US); The Board of Trustees of the University of Illinois, Urbana, IL (US)

(21) Appl. No.: 18/554,963

(22) PCT Filed: Apr. 13, 2022
(86) PCT No.: PCT/US2022/024702

§ 371 Date: Oct. 11, 2023

Related U.S. Application Data
(60) Provisional application No. 63/174,383, filed on Apr. 13, 2021.

(51) Int. Cl. G06F 15/173; G06F 13/42

(52) U.S. Cl. CPC G06F 15/17381; G06F 13/4221; G06F 15/17331

(57) ABSTRACT

A densely integrated and chiplet/dielet based networked memory pool with very high intra-pool bandwidth is provided. Chiplets are used to provide a common interface to the network. This means all memories (even those built with different process technologies) look the same from the network's perspective and vice versa: memory can be assembled in many different configurations while only changing the configuration at a high level of abstraction. The memory pool can easily be scaled in capacity and custom configurations that were previously impossible to achieve because of incompatibility of different technologies or level of integration are made possible.

### CROSS-REFERENCE TO RELATED APPLICATIONS

The present application claims priority to U.S. Provisional Patent Application No. 63/174,383 filed Apr. 13, 2021, the contents of which are incorporated by reference herein in their entirety.

### TECHNICAL FIELD

The present embodiments relate generally to computing, and more particularly to densely integrated and chiplet/dielet based networked memory pools with very high intra-pool bandwidth.

### BACKGROUND

Data intensive applications require more memory capacity and bandwidth than what a single processing node can provide. As a result, large shared memory systems are often built by interconnecting multiple processing nodes where each processing node consists of a compute chip(s) and random access memory (RAM). The RAM is connected to the compute chip and is controlled by the compute chip alone. Compute chips from other nodes access memory from a non-local RAM on a different node by sending requests to the compute chip of that node over the inter-node interconnect. There are two major issues with this approach. The first is that it introduces bottlenecks in the system. The second is that it constrains the design space resulting in worse memory utilization and performance.

It is against this backdrop that the present Applicants sought to advance the state of the art by providing a technological solution to these and other problems rooted in this technology.

### SUMMARY

According to certain aspects disclosed herein, a technological solution to these and other issues is provided. An embodiment includes a densely integrated and chiplet/dielet based networked memory pool with very high intra-pool bandwidth. Chiplets are used to provide a common interface to the network. For example, all memories (even those built with different process technologies) can look the same from the network's perspective and vice versa; memory can be assembled in many different configurations while only changing the configuration at a high level of abstraction. The memory pool can easily be scaled in capacity and custom configurations that were previously impossible to achieve because of incompatibility of different technologies or level of integration are made possible.

### BRIEF DESCRIPTION OF THE DRAWINGS

These and other aspects and features of the present embodiments will become apparent to those ordinarily skilled in the art upon review of the following description of specific embodiments in conjunction with the accompanying figures, wherein:

FIG. 1 illustrates an example overall system with a densely integrated memory pool according to embodiments.

FIG. 2 illustrates an example memory pool comprising a collection of memory blocks, all connected through a network according to embodiments.

FIG. 3 illustrates an example memory pool comprising a collection of memory chiplets all connected through a network according to embodiments.

FIG. 4 illustrates an example implementation of a memory pool where standalone memory chiplets are used alongside network router and memory controller chiplet according to embodiments.

FIG. 5 illustrates an example memory pool architecture according to embodiments where a mesh network topology is used.

FIG. 6 illustrates an example memory pool architecture according to embodiments in which a folded-torus network topology is used.

FIG. 7 illustrates an example memory pool architecture according to embodiments where a subset of the memory chiplets can be replaced with memory chiplets containing in-memory compute blocks or with compute chiplets.

FIG. 8 illustrates an example memory pool architecture according to embodiments where a subset of network chiplets include computing capabilities.

### DETAILED DESCRIPTION

The present embodiments will now be described in detail with reference to the drawings, which are provided as illustrative examples of the embodiments so as to enable those skilled in the art to practice the embodiments and alternatives apparent to those skilled in the art. Notably, the figures and examples below are not meant to limit the scope of the present embodiments to a single embodiment, but other embodiments are possible by way of interchange of some or all of the described or illustrated elements. Moreover, where certain elements of the present embodiments can be partially or fully implemented using known components, only those portions of such known components that are necessary for an understanding of the present embodiments will be described, and detailed descriptions of other portions of such known components will be omitted so as not to obscure the present embodiments. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the present disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present embodiments encompass present and future known equivalents to the known components referred to herein by way of illustration.

As set forth above, many applications require more memory capacity and bandwidth than can be provided by a single processing node. Conventional solutions in use today require connecting multiple processing nodes together using interconnection technologies which are limited in latency and bandwidth. Existing interconnection technologies that offer lower latency and higher bandwidth (e.g., network on chip) are not scalable and make integrating heterogeneous technologies (DRAM, SRAM, Flash, MRAM etc.) more difficult than slower interconnects. Among other things, the present Applicants aim to solve these and other problems by providing a tightly integrated large capacity memory pool system that can be connected to many processing nodes simultaneously and an assembly-based design process for that memory pool. Different components of the memory pool are realized as disparate chiplets which are then integrated on a high density interconnect substrate in arbitrary configurations. By swapping and moving chiplets and/or redesigning the wiring on the interconnect substrate, a new system configuration with custom memory performance characteristics can be quickly realized, this can help tune the performance characteristics to application behavior in order to achieve superior cost-performance-energy trade-off.

Relatedly, as also set forth above, data intensive applications require more memory capacity and bandwidth than what a single processing node can provide. As a result, large shared memory systems are often built by interconnecting multiple processing nodes where each processing node consists of a compute chip(s) and random access memory (RAM). The RAM is connected to the compute chip and is controlled by the compute chip alone. Compute chips from other nodes access memory from a non-local RAM on a different node by sending requests to the compute chip of that node over the inter-node interconnect. There are two major issues with this approach. The first is that it introduces bottlenecks in the system. The second is that it constrains the design space resulting in worse memory utilization and performance. One solution to these and other problems provided herein is to build a densely integrated and chiplet/dielet based networked memory pool with very high intra-pool bandwidth. Chiplets are used to provide a common interface to the network. This means all memories (even those built with different process technologies) look the same from the network's perspective and vice versa; memory can be assembled in many different configurations while only changing the configuration at a high level of abstraction. The memory pool can easily be scaled in capacity and custom configurations that were previously impossible to achieve because of incompatibility of different technologies or level of integration are made possible.

Existing interconnects connecting compute nodes limit scalability and introduce significant bottlenecks for any application running across multiple nodes (shown in Table 1 below). Because the RAMs are separated, applications which share data across multiple nodes need to move data from one node to another over the inter-node interconnect, thus resulting in performance bottlenecks.

TABLE 1
An example memory pool on a waferscale interconnect
according to embodiments delivers previously unachievable
capacity, bandwidth, and latency as well as easy configurability
for different system interfaces:

| | Conventional | Waferscale | | |
|---|---|---|---|---|
| | System | Memory Pool | | Benefit |
| Capacity Per | 1-4 TB (DRAM) | 1 TB-12 | | 3x |
| Board/Blade | | TB (DRAM) | | |
| Bisection | 160 GB/s (Intel | 20 | TB/s | 125x |
| Bandwidth | UPI - 4 sockets) | | | |
| Latency | 70 ns-150 ns | 75-100 | ns | 1x |

| | | | |
|---|---|---|---|
| Total DRAM | 32 (DDR4) | 384 (DDR4) | >12x |
| Channels | | | |
| Interface | Homogeneous | Heterogeneous | — |
| | (DDRx or PCle) | (DDRx + | |
| | | PCle + RDMA) | |

In the present design, many processors connect to the memory pool and access the whole memory space through their connection. The functionality of the inter-node interconnect is replaced with that of the memory pool's network which has much higher bandwidth and lower latency links. Such an architecture alleviates the inter-node network bottleneck and provides a high bandwidth shared memory substrate.

By replacing a subset of chiplets or by changing the interconnect fabric, the latency, bandwidth, capacity, and other characteristics of the memory pool can be tuned based on the application and the processor architecture. Three possible design points are shown in Table 2 below. An application requiring massive bandwidth may want more SRAM as shown in the first column. In this example, using stacked SRAM only (e.g. eight stacks), the aggregate bandwidth is 400 TBps, while the capacity per board is 1 TB. In another example shown in the third column, an application requiring massive capacity may want more flash memory (e.g. NAND flash). As shown, a flash-only application achieves an overall capacity per board of 30 TB, while the aggregate bandwidth falls to 1 TBps. The middle column illustrates an example point in between the other examples, and is achievable by mixing different memory technologies as well as using other intermediate technologies like DRAM.

TABLE 2
A previously unachievable range of capacity, performance,
and price is achievable by mixing heterogeneous
technologies with tight integration:

| | SRAM | | HBM2E | | Flash | |
|---|---|---|---|---|---|---|
| | Memory Pool | | Memory Pool | | Memory | |
| | (8-layer stacks) | | (8-layer stacks) | | Pool | |
| Capacity Per Board | 1 | TB | 12 | TB | 30 | TB |
| Aggregate Bandwidth | 400 | TBps | 250 | TBps | 1 | TBps |
| Memory Node Latency | 5 | ns | 25 | ns | 50-500 | μs |

| | | | |
|---|---|---|---|
| Price per GB | $80 | $7 | $0.50 |

Table 3 below shows the tradeoffs possible given that one can easily change the topology. A mesh can be chosen if bandwidth is the priority (as illustrated in the example in the first column) and a folded torus can be chosen if the priority is latency (as illustrated in the middle column). Because the present embodiments use chiplets with common interfaces, changes to the topology can be made without changing the memory nodes and vice versa (as illustrated in the last column, where a 5-hop bypass is implemented in the mesh topology configuration). The development effort is quantized in a way previously impossible at this degree of integration.

TABLE 3
Tight integration means the interconnect can be
configured so it does not add bottlenecks in the
performance dimension that is most important.

| | Mesh | | Folded Torus | | Mesh w/ | |
|---|---|---|---|---|---|---|
| | Topology | | Topology | | 5-hop Bypass | |
| Bisection bandwidth | 20 | TB/s | 20 | TB/s | 20 | TB/s |
| Maximum latency | 81 | ns | 53 | ns | 26 | ns |
| Aggregate Bandwidth | 760 | TB/s | 380 | TB/s | 250 | TB/s |

Another problem the present embodiments help solve is variability in memory interfaces. Different types of processors often use different memory interfaces, such as DDRx/LPDDRx/GDDRx/PCIe, UCIe, etc. and new memory and communication interfaces are being developed, e.g., OMI, Gen-Z, CXL etc. However, today's systems are not easily customizable and often one-size fits all solutions are used, which results in sub-optimal performance and power characteristics and may even lead to incompatibility with a memory system. Using the present chiplet based approach, the interface can be replaced without modifying the rest of the system because each memory interface is translated to the common interface understood by the memory pool's network.

In one embodiment, a large number of RAM devices/chiplets, network chiplets and interface chiplets are integrated on an interconnect fabric device. By designing the chiplets with common interfaces, they can be placed in any configuration while maintaining the performance of the network. Therefore, the appropriate chiplet, memory device, interconnection topology can be chosen at any location on the device to meet the needs of a given class of applications.

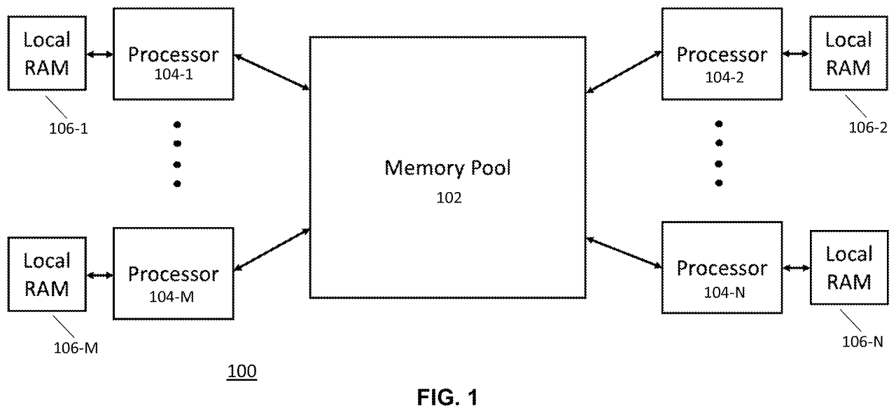

According to embodiments, as shown in FIG. 1, a heterogeneous and reconfigurable memory pool system 100 comprises a memory pool 102 including a plurality of memory nodes interconnected together through chiplets with common interfaces. A plurality of processors 104-1 to 104-N can connect to the memory pool 102 simultaneously as shown in FIG. 1 via a network. Each of the processors 104 can either share the entire memory capacity or a part of the memory capacity. In the example shown in FIG. 1, processors 104 are connected to the shared memory pool 102 and also include their own local RAM 106. Such a system 100 with very high bandwidth can efficiently share data without today's inter-socket interconnect bandwidth bottlenecks.

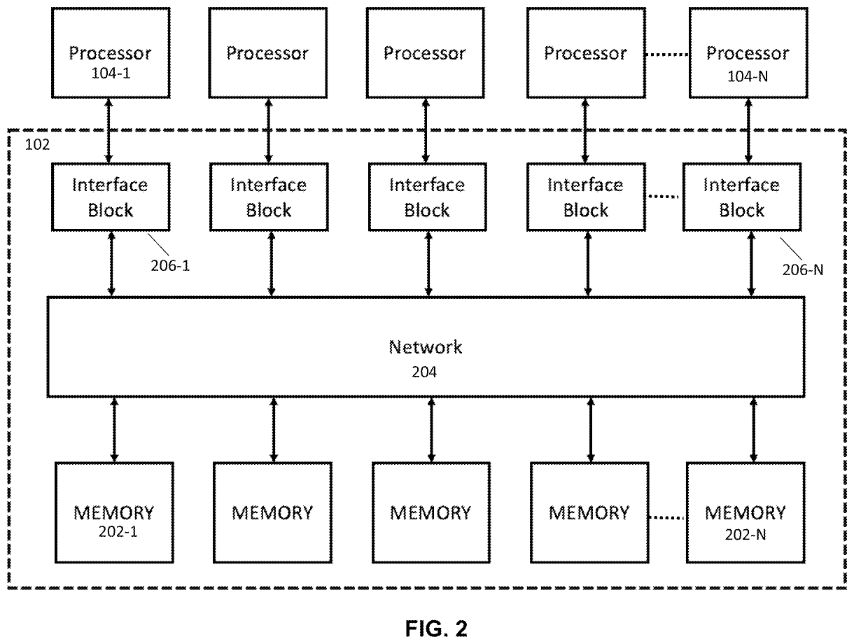

As set forth above, the memory pool 102 shown in FIG. 1 may comprise a set of memory nodes connected through a network. FIG. 2 illustrates an example where the memory pool 102 is a collection of memory blocks 202, all connected through a network 204. Interface blocks 206 allow external processors 104 or other logic units to communicate with the network in order to access the memory blocks 202.

As shown in this example, a memory node consists of a set of memory blocks/devices and/or chiplets 202 including accessible memory (e.g SRAM, DRAM, Flash memory), where there is at least one chiplet capable of communicating through the network 204 with common interface. A set of interface chiplets 206 (e.g. implementing DDRx/LPDDRx/GDDRx/PCIe, UCle, CXL interfaces, etc.) are used to connect a set of processors to the network of memories. In this example, each processor interface block 206 can connect to one or more processors 104 and one or more ports on the network 204. The network topologies that the common chiplet interface was designed to support (e.g., mesh, torus, random, and/or cross-bar topologies) can be realized by interconnecting the chiplets over an interconnect substrate, as will be described in more detail below.

As used herein, the term chiplet (or sometimes dielet) refers to a low-cost technology for integrating heterogeneous types of functionality in processors with customizability for various applications. Example aspects of this technology are described in S. Pal, D. Petrisko, A. A. Bajwa, P. Gupta, S. S. Iyer and R. Kumar, “A Case for Packageless Processors,” 2018 IEEE International Symposium on High Performance Computer Architecture (HPCA), Vienna, 2018, pp. 466-479, doi: 10.1109/HPCA.2018.00047; S. Pal, D. Petrisko, M. Tomei, P. Gupta, S. S. Iyer and R. Kumar, “Architecting Waferscale Processors—A GPU Case Study,” 2019 IEEE International Symposium on High Performance Computer Architecture (HPCA), Washington, DC, USA, 2019, pp. 250-263, doi: 10.1109/HPCA.2019.00042; and S. Pal, D. Petrisko, R. Kumar and P. Gupta, “Design Space Exploration for Chiplet-Assembly-Based Processors,” in IEEE Transactions on Very Large Scale Integration (VLSI) Systems, vol. 28, no. 4, pp. 1062-1073, April 2020, doi: 10.1109/TVLSI.2020.2968904. The contents of these publications are incorporated by reference herein for purposes of the present disclosure. In other embodiments, conventional technologies such as SoC can be used, either alone, or in combination with chiplet technology.

Network 204 can be any type of wired or wireless network (e.g. Ethernet, Internet, etc.). However, as described in more detail below, network 204 in some embodiments can be implemented using a wired or wireless network having a desired topology such as mesh or torus, as will be appreciated by those skilled in the art.

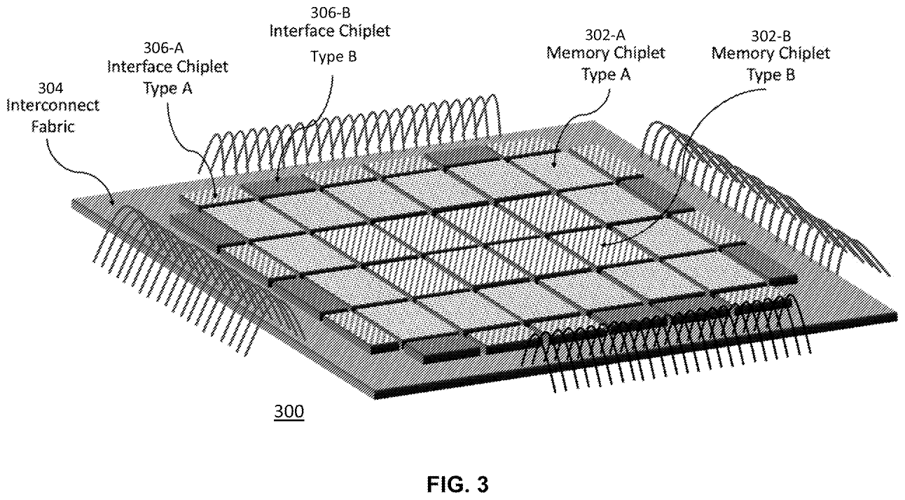

FIG. 3 illustrates an example memory pool system 300 where the memory pool 102 is a collection of memory chiplets 302 all connected through a network. The interface blocks 306 (e.g. implementing DDRx/LPDDRx/GDDRx/PCIe, UCIe, CXL interfaces, etc.) allow external processors (e.g. processors 104, etc.) or other logic units to communicate with the network in order to access the memory blocks. All the chiplets are integrated on an interconnect fabric/substrate 304 which has the circuitry and wiring to interconnect different chiplets. The wiring scheme on the interconnect fabric 304 results in the overall network topology. Those skilled in the art will understand how to implement such wiring schemes based on the desired network topology after being taught by the present examples.

Chiplets 304-A is a chip comprising one or a plurality of memory dies of a particular memory technology such as SRAM, DRAM, Flash, etc. Chiplet 304-B is another chip comprising one or a plurality of memory dies of a particular memory technology such as SRAM, DRAM, Flash, etc. The number, capacity and/or type of memory in chiplet 304-A and 304-B are different.

Chiplet 306-A is a chip comprising one or more processors and/or cores implementing a memory interface (e.g. one of DDRx/LPDDRx/GDDRx/PCIe, UCIe, CXL interfaces, etc.), along with functionality for interfacing with network 204. Chiplet 306-B is a chip comprising one or more processors and/or cores implementing a memory interface (e.g. one of DDRx/LPDDRx/GDDRx/PCIe, UCIe, CXL interfaces, etc.), along with functionality for interfacing with network 204. The type and/or capacity of memory interface in chiplets 306-A and 306-B are different.

Interconnect substrate 304 can be an active or a passive silicon interconnect device or any other interconnect device such as interposers (organic, glass or silicon), EMIB, TSMC's SoW, etc. and would contain the interconnect circuitry to connect all the chiplets and devices integrated on it.

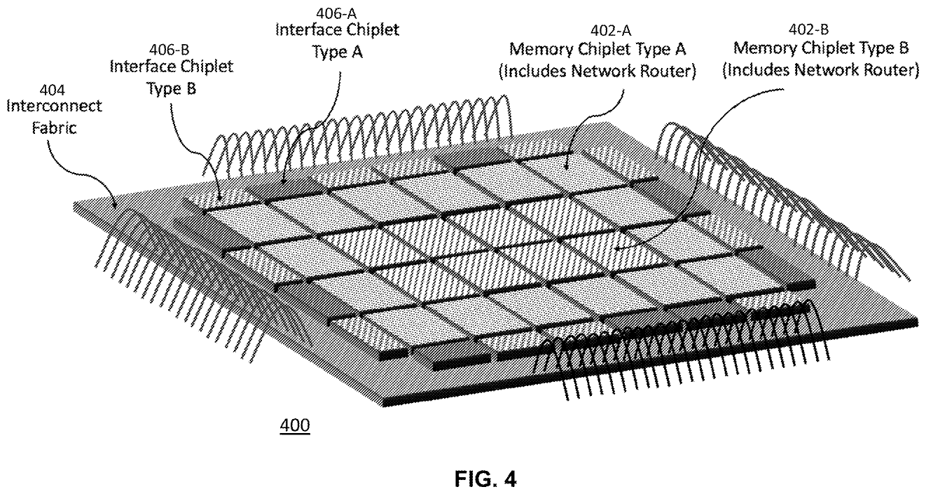

FIG. 4 illustrates an example implementation of the memory pool 102 in a memory pool system 400 where standalone memory devices are incorporated alongside network routers and memory controllers in a single chiplet 402-A. In another incarnation, a separate chiplet 402-B with only a network router and memory controller would be used. Interface blocks 406 can be similar to chiplets 406 described above and interconnect substrate 404 can be similar to interconnect substrate 304 described above.

In either system 300 or 400, the set of allowable memory nodes and therefore the memory pool system can be built by assembling heterogeneous memories and/or heterogeneous chiplets (chiplets can either be a single layer or multi-layer 3D structure). The nodes can be assembled on interconnect substrate 304, 404 to form the memory pool. The memory nodes includes in chiplets 302, 402 may comprise a subset of the following blocks: memories (such as SRAM, DRAM, Flash), memory controllers, networking logic such as routers, arbiters etc and other logic for near memory computing and supporting hardware based atomic operations. Because of the common network interface, memory blocks may be implemented as chiplets themselves (as shown in FIG. 3) or prefabricated without the network and reconfiguration in mind. In the latter case, the memory node must contain at least the memory device and a network interface chiplet (shown in FIG. 4) with a common interface to allow for reconfigurability. Different memory technologies such as SRAM, DRAM, MRAM, Flash etc. which differ in memory density, cost, latency, bandwidth and power can be used to implement memory nodes (e.g. chiplets 302, 402) and therefore the memory pool different performance characteristics.

The communication between the different memory nodes would be accomplished by building circuitry and/or wiring in the interconnect substrate 304, 404. In one possible embodiment, this wiring is built using technologies for which designing a new interconnect has low cost (e.g., Silicon Interconnect Fabric). Therefore, interconnect design can be used to configure the network topology and thus the performance of the memory pool in addition to the choice of memory nodes.

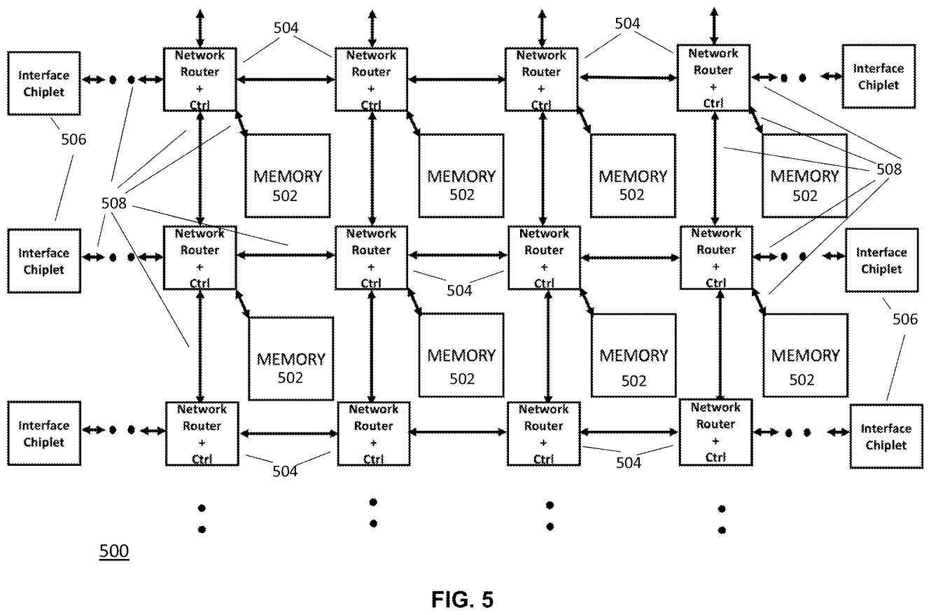

FIG. 5 illustrates an example memory pool system 500 such as described above in connection with FIG. 4 in which the wiring connections 508 in interconnect substrate 404 implement a mesh topology. In this example of FIG. 5, memories 502 and network routers 504 implement chiplets 402 in FIG. 4 and chiplets 506 in FIG. 5 implement chiplets 406 in FIG. 4.

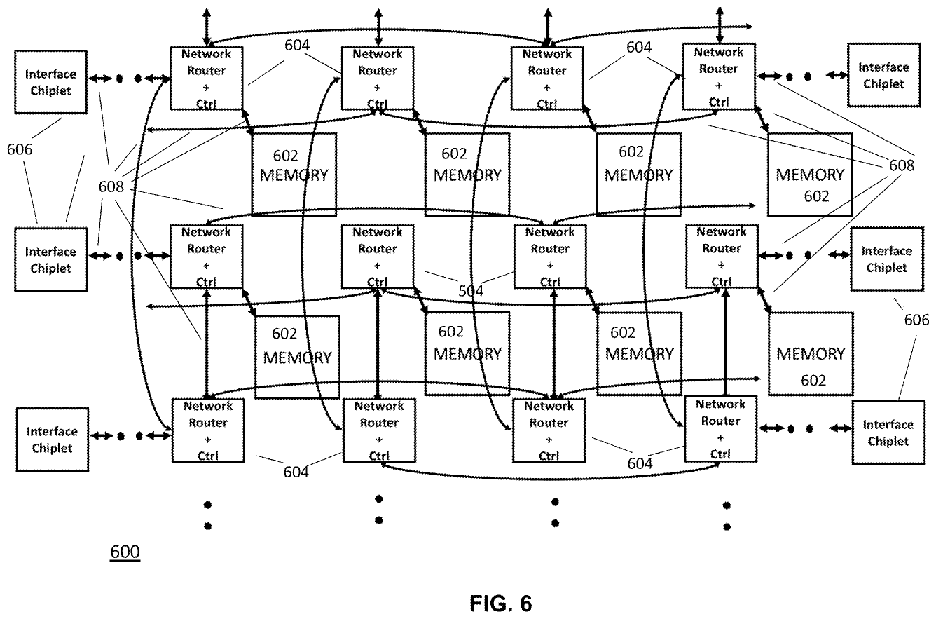

FIG. 6 illustrates an example memory pool system 600 such as described above in connection with FIG. 4 in which the wiring connections 608 in interconnect substrate 404 implement a folded-torus topology. In this example of FIG. 6, memories 602 and network routers 604 implement chiplets 402 in FIG. 4 and chiplets 606 in FIG. 6 implement chiplets 406 in FIG. 4.

Those skilled in the art will understand that different network topologies can be realized by just changing the interconnect fabric/substrate 304, 404 design while keeping the same chiplets integrated on the interconnect substrate.

Further customization of the memory pool can be done by selecting memory nodes containing one or more different memory technologies in chiplets 302, 402. Since different memory technologies differ in memory density, bandwidth and latency, the ratio and placement of the memory nodes using these different technologies can provide customizable properties and characteristics for the overall memory pool and help tailor the system to application properties. One possible chiplet based system integration, where the chiplet interfaces are designed such that chiplets of different characteristics can be swapped, allows one to achieve this goal of system reconfiguration easily without the need to change other components of the system.

Each memory technology requires a different memory controller and so the memory controller logic, either in the same chiplet as the memory or on a different chiplet as described above in connection with FIG. 4, must be custom to the memory nodes using that technology. The memory controller may be implemented as a separate chiplet to allow for easy generation of new memory nodes for the same memory technology.

Similarly, network elements such as routers, arbiters etc. can be implemented as separate chiplets as shown in FIG. 4, which can be reused across memory nodes using different memory technologies. Alternatively, different types of network chiplets targeting different network characteristics can be implemented as well, and just by replacing the network chiplets, different network parameters could be tuned. In some cases including the example shown in FIG. 4, memory nodes in the memory pool may contain no storage capacity and serve solely to tune the characteristics of the network.

As mentioned earlier, the chiplets would be integrated on an interconnect substrate 302, 402 and the inter-chiplet communication would take place through the substrate. As described above, the interconnect substrate can be an active or a passive silicon interconnect device or any other interconnect device such as interposers (organic, glass or silicon), EMIB, TSMC's SoW, etc. and would contain the interconnect circuitry to connect all the chiplets and devices integrated on it. The network topology is dictated by the wiring topology that is being built into the interconnect substrate. As a result, the interconnect substrate in itself, provides another axis of reconfiguration. Just by changing the wiring on the interconnect substrate, different network topologies can be realized which would allow for different latency-bandwidth trade-offs as well.

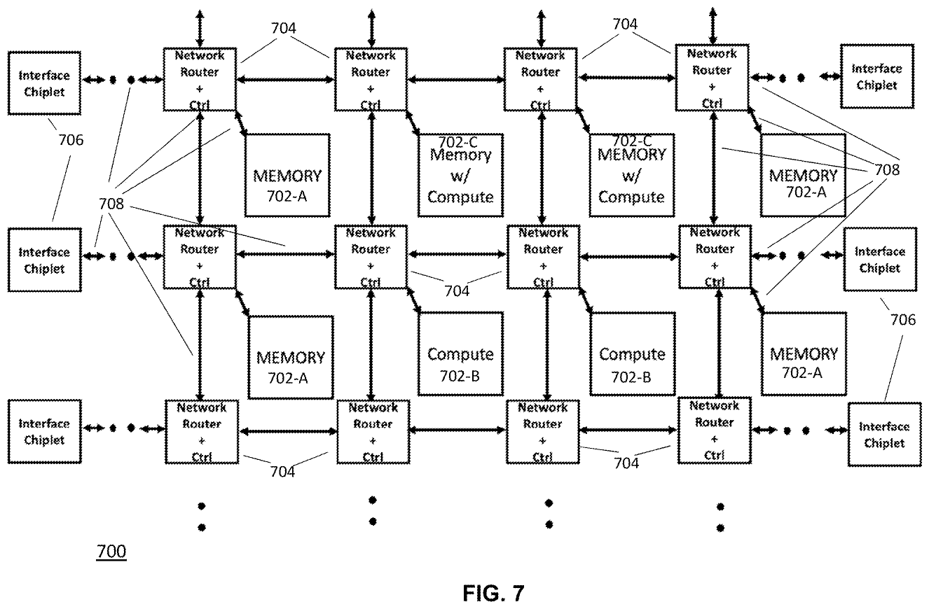

The proposed chiplet based memory pool system can also be extended to include in-memory or near memory compute chiplets. As shown in FIG. 7, one or more of the memory-only chiplets 702-A (e.g. 302, 402 in FIG. 3, 4) can be replaced with memory chiplets with in-memory compute/processing capabilities (e.g. 702-C) or even with just compute chiplets (e.g. 702-B). Such a system would be ideally suited for applications which can leverage near-memory compute capabilities for additional performance and energy efficiency benefits. Moreover, the compute can also leverage the very large amount of interconnect network bandwidth available inside the pool. For example, FIG. 7 illustrates an example memory pool architecture is shown where a subset of the memory chiplets 702-A can be replaced with memory chiplets containing in-memory compute blocks 702-C or with compute chiplets 702-B.

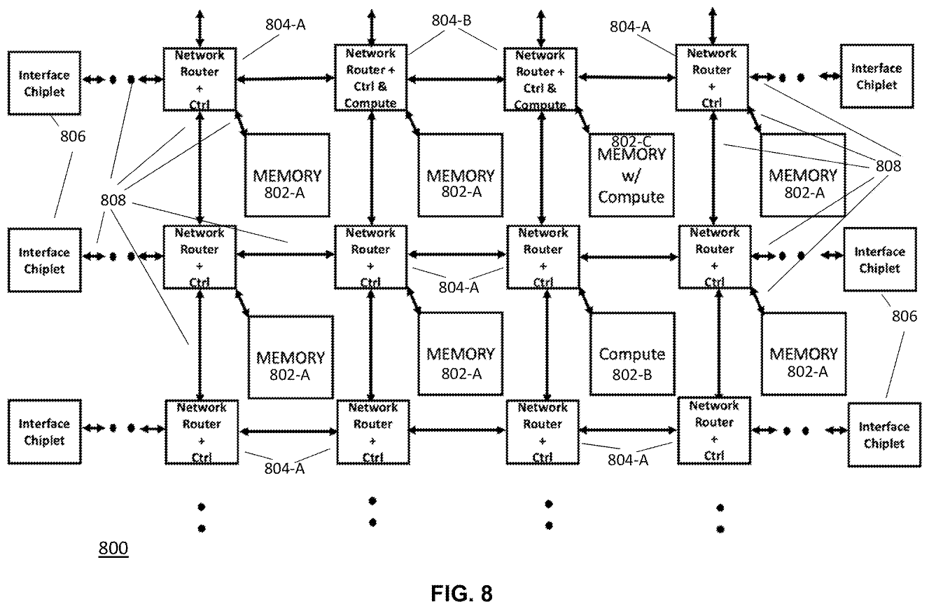

Moreover, another way including compute in the memory pool is to introduce compute capability in the network itself. One way to achieve this is to add compute blocks to the network chiplets (e.g. 804-B in FIG. 8). Such a system would enable the advantages of near-memory compute, similar to the benefits of the system proposed in FIG. 7, but additionally it would also help perform in-network computation such as accumulation, reduction, network message filtering etc. For example, FIG. 8 illustrates an example memory pool architecture is shown where a subset of network chiplets 804-B include computing capabilities.

Another functionality provided by this architecture would be direct communication between the different interface chiplets (which wouldn't involve any memory accesses). This would allow multiple processors to communicate among each other or with external compute or memory devices using the high bandwidth network on the interconnect substrate, essentially working as a network switching device. In this instantiation, one or more of the memory nodes may not contain storage (i.e., left empty) as it is not required for communication between interfaces.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably coupleable,” to each other to achieve the desired functionality. Specific examples of operably coupleable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

Although the present embodiments have been particularly described with reference to preferred examples thereof, it should be readily apparent to those of ordinary skill in the art that changes and modifications in the form and details may be made without departing from the spirit and scope of the present disclosure. It is intended that the appended claims encompass such changes and modifications.

1. A system comprising:
a plurality of memory nodes implemented by chiplets; and
a network fabric connected to each of the plurality of memory nodes.

2. The system of claim 1, further comprising a plurality of interface blocks implemented by chiplets that provide a common interface to the network fabric to external processors.

3. The system of claim 1, wherein the network fabric implements a mesh topology for connecting the plurality of memory nodes.

4. The system of claim 1, wherein the network fabric implements a folded torus topology for connecting the plurality of memory nodes.

5. The system of claim 1, wherein the network fabric comprises a silicon substrate or non-silicon substrate.

6. The system of claim 1, wherein one of the plurality of memory nodes implements a first memory type, and a second one of the plurality of memory nodes implements a second memory type, the first and second memory types being different.

7. The system of claim 1, wherein one of the plurality of memory nodes includes a memory controller, and a second one of the plurality of memory nodes does not include a memory controller.

8. The system of claim 1, wherein one of the plurality of memory nodes includes a network router, and a second one of the plurality of memory nodes does not include a network router.

9. The system of claim 1, further comprising one or more compute chips connected to the network fabric.

10. The system of claim 2, wherein the common interface comprises one or more of DDRx, LPDDRx, GDDRx, PCIe, UCIe and CXL.

11. The system of claim 2, wherein the memory nodes are on a separate substrate from the network fabric and the interface blocks, and also connect to the network fabric via the interface blocks.

12. A method of providing a memory pool system comprising:
selecting a plurality of memory nodes implemented by chiplets, wherein selecting includes determining one or more of a memory type and a memory capacity of the plurality of memory nodes according to a desired application; and
connecting each of the plurality of memory nodes to a network fabric.

13. The method of claim 12, further comprising configuring the network fabric to implement a mesh topology for connecting the plurality of memory nodes.

14. The method of claim 12, further comprising configuring the network fabric to implement a folded torus topology for connecting the plurality of memory nodes.

15. The method of claim 12, wherein the memory type of the memory nodes comprises one or more of SRAM, DRAM, MRAM, and Flash.
